(19) United States
(12) Patent Application Publication
(10) Pub. No.: US 2004/0244036 A1
(43) Pub. Date: Dec. 2, 2004

(54) Channel combining and decombining systems and methods for television program transmitting and receiving

(75) Inventor: Winston Hugh Wright, Rancho Palos Verdes, CA (US)

Correspondence Address: Mitchell S. Bigel, Myers Bigel Sibley & Sajovec, P.A., P. O. Box 37428, Raleigh, NC, 27627, US

(73) Assignee: Microspace Communications Corporation, Raleigh, NC

(21) Appl. No.: 10/848,420

(22) Filed: May 18, 2004

Related U.S. Application Data
(60) Provisional application No. 60/473,754, filed on May 28, 2003.

(51) Int. Cl. H04N 7/16; H04N 7/18; H04N 7/10; H04N 7/025; H04N 9/47

(52) U.S. Cl. 725/32; 725/135; 725/36; 348/142

(57) ABSTRACT

Television program transmitting methods and systems transmit multiple program channels when at least some of the multiple program channels have different content, and transmit a single program channel in place of the multiple program channels when the multiple program channels have common content. Additional content may be transmitted on at least one of the program channels that have freed up when the multiple program channels have common content.

### CROSS-REFERENCE TO PROVISIONAL APPLICATION

This application claims the benefit of and priority from provisional Application No. 60/473,754, filed May 28, 2003, entitled Channel Combining and Decombining in DBS Systems, assigned to the assignee of the present application, the disclosure of which is hereby incorporated herein by reference in its entirety as if set forth fully herein.

### FIELD OF THE INVENTION

This invention relates to transmitting and receiving methods and systems, and more particularly to systems and methods for transmitting and receiving television broadcasts.

### BACKGROUND OF THE INVENTION

Direct Broadcast Satellite (DBS) television (TV), cable television, terrestrial, and Internet television broadcast (transmission) and receiving systems, methods and transmission formats are widely used. As is well known to those having skill in the art, these systems and methods generally include a broadcast system, such as DBS ground and space segments, a cable TV head end and an Internet TV server, and a receiver that is often referred to as a “set top box” and that is configured to receive television signals and provide these signals to a television receiver. The term “set top box” is used herein generically to refer to a user control center for receiving DBS, cable and/or Internet television broadcasts, and providing a television program output to a television receiver. The set top box functionality may be integrated at least partially in a television and/or other device, such as a digital video recorder. Moreover, as used herein, a television receiver is used generically to include any audio and/or video playing system, including a video monitor, computer display, audio system and/or home theater system.

As the number of television channels increases and new services are introduced, DBS systems and methods may be constrained by the fixed bandwidth available to them. Similar constraints may also apply to cable television and Internet television.

For example, it may be desirable for local television channels to be broadcast by DBS systems. There are about 1700 full power TV stations in the United States. Currently, DBS systems may not be able to deliver all these stations to their customers, at least partly because of bandwidth constraints. The advent of High Definition Television (HDTV), which generally uses more bandwidth than standard television delivered today, may further aggravate this situation.

One technique employed by DBS system operators (broadcasters) in their effort to deliver more services is to re-use their bandwidth. Instead of broadcasting a signal to the entire country in a national satellite beam, it is possible to focus signals in a smaller region by the use of spot beams. If a large number of spot beams is defined by the satellite it is possible to re-use a frequency many times. Therefore, in current and in future satellites spot beams can be used, particularly in the broadcast of local television content, and generally for any content that is intended for a local rather than a national audience.

Local television is divided into Designated Market Areas (DMAs). The United States market currently consists of 210 DMAs. This number is adjusted from time to time. Some of these markets are small geographically and it may not be practical to design a satellite that allocates a spot beam to each of the markets. Accordingly, it is known to provide regional spot beams, each of which can cover several markets.

### SUMMARY OF THE INVENTION

Television program transmitting methods according to some embodiments of the present invention transmit a plurality of program channels when at least some of the plurality of program channels have different content, and transmit a single program channel in place of the plurality of program channels when the plurality of program channels have common content. In some embodiments, additional content is transmitted on at least one of the plurality of program channels when the plurality of program channels have common content. As used herein, a “program channel” denotes a grouping of a video stream with associated audio and data streams. Multiple such program channels can be multiplexed together and assigned a given carrier frequency in a television broadcasting system. Capacity within such a multiplex can be allocated and reallocated among individual programs channels and/or can be reallocated to a single program channel.

In some embodiments, transmitting a single program channel is enabled by combining the plurality of program channels into the single program channel when the plurality of program channels have common content. Moreover, in some embodiments, transmitting a plurality of program channels is enabled by decombining the single program channel into the plurality of program channels when at least some of the plurality of program channels have different content.

In some embodiments, the common content comprises national content, regional content or local content, and the different content comprises regional content, local content or commercials, respectively. In other embodiments, the common content comprises a common television program and the different content comprises different commercials. In yet other embodiments, the additional content comprises a high bit rate transmission of the common content, HDTV content and/or content to be stored in a set top box. In some embodiments, the above-described embodiments are performed by a DBS broadcasting system.

Analogous receiving methods may be provided according to some embodiments of the present invention, wherein a plurality of program channels is received when at least some of the plurality of program channels have different content, and a single program channel is received in place of the plurality of program channels when the plurality of program channels have common content. Additional content may be received as was described above, and the common content and the different content may be as was described above. These television program receiving methods may be performed in a DBS set top box.

Television program broadcasting systems according to some embodiments of the present invention include a transmitter that is configured to transmit a plurality of program channels when at least some of the plurality of program channels have different content, and to transmit a single program channel in place of the plurality of program channels when the plurality of program channels have common content. In some embodiments, the transmitter is further configured to transmit additional content on at least one of the plurality of program channels when the plurality of program channels have common content. In yet other embodiments, a second transmitter is provided that is configured to transmit additional content on at least one of the plurality of program channels when the plurality of program channels have common content.

In still other embodiments of television program broadcasting systems, a switch is provided that is configured to select a plurality of programs channels to be multiplexed together in place of the single program channel (decombining) when at least some of the plurality of program channels have different content, and to select the single program in place of the plurality of program channels (combining) when the plurality of program channels have common content. The transmitter is responsive to the switch. The common content and different content may be as was described above. In yet other embodiments, a synchronizer also is provided that is configured to synchronize the plurality of program channels, and the switch is responsive to the synchronizer.

Finally, set top boxes according to some embodiments of the present invention can include a receiver that is configured to receive at least one of a plurality of program channels (depending on the market in which the receiver is located) when at least some of the plurality of program channels have different content, and to receive a single program channel in place of at least one of the plurality of program channels when the plurality of program channels have common content. Additional content also may be received as was described above. The set top box may be a DBS set top box in some embodiments.

### BRIEF DESCRIPTION OF THE DRAWINGS

FIG. 1 is a block diagram of systems and methods according to embodiments of the present invention.

FIGS. 2-5 are flowcharts of operations that may be performed according to various embodiments of the present invention.

FIGS. 6-10 are block diagrams of systems and methods according to other embodiments of the present invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. It will be understood that when an element is referred to as being “responsive to” or “controlled by” another element, it can be directly responsive to or controlled by the other element or intervening elements may be present. In contrast, when an element is referred to as being “directly responsive to” or “directly controlled by” another element, there are no intervening elements present.

It will also be understood that although the terms first and second are used herein to describe various elements, these elements should not be limited by these terms. These terms are only used to distinguish one element from another element. Thus, a first element below could be termed a second element, and similarly, a second element may be termed a first element without departing from the teachings of the present invention. As used herein, the term “and/or” includes any and all combinations of one or more of the associated listed items.

The present invention is described below with reference to block diagrams and/or flowchart illustrations of methods, apparatus (systems) and/or computer program products according to embodiments of the invention. It is understood that each block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Some embodiments of the present invention may arise from recognition that, for example, local television stations can belong to networks or other groupings. This can lead to the same program being broadcast simultaneously by many stations. For example, the broadcast of sitcoms, or news and sporting programs, can be duplicated many times by stations across the country. This also may happen in a regional spot beam spanning several markets. The signal of every station belonging to the beam generally is broadcast even when the program content is identical. It is possible to broadcast the program only once in the beam and have all subscribers in the beam receive the singular broadcast. This is generally not done, however, because the local stations insert their individual commercial messages into the program stream. When this happens the content no longer is identical.

Some embodiments of the invention can combine a group of channels broadcasting identical material into a single channel. When a situation arises, such as a commercial break, in which the material broadcast by stations in the group is different, the single channel is decombined into the group of channels. Thus, in some embodiments, material intended specifically for an individual locality can be broadcast to only that locality. Embodiments of the invention can be applied to the channels in a single regional spot beam, or to a collection of regional spot beams, and/or to a national beam. Moreover, embodiments of the invention may be especially beneficial for, and are described herein with respect to, DBS systems/methods, but may also apply to cable TV, terrestrial, and/or Internet TV.

Embodiments of the invention can result in saving bandwidth that can be employed in higher bit rate transmissions of the program, and/or for the injection of additional information into a DBS bit stream. Some of this information can be stored in a set top box for later use.

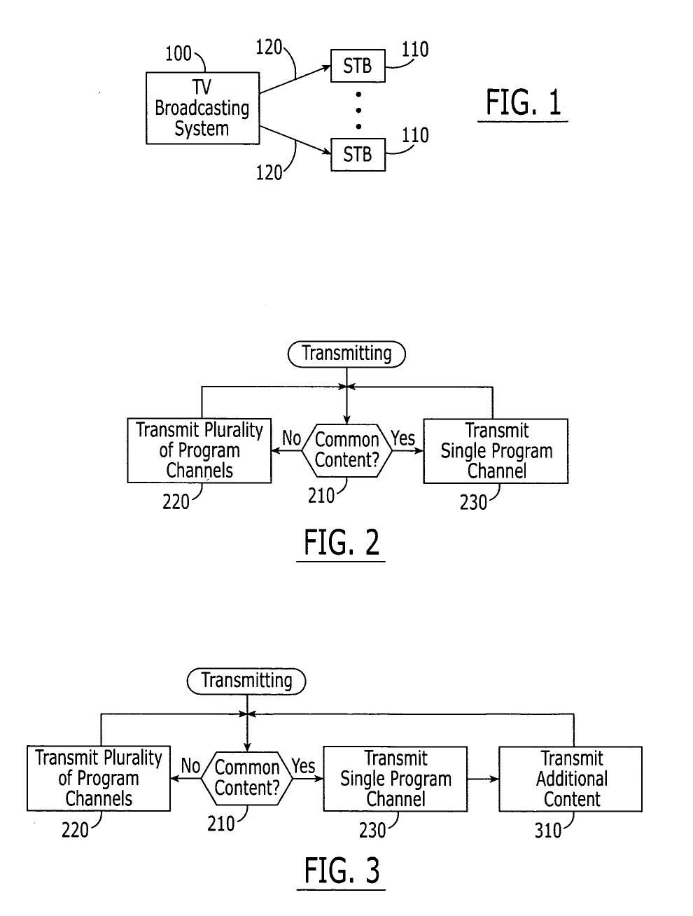

FIG. 1 is a block diagram of systems and methods for television program transmitting and receiving according to various embodiments of the present invention. As shown in FIG. 1, a television broadcasting system 100 which may include a DBS uplink system, a cable TV head end, terrestrial broadcast system, and/or an Internet server, is configured to transmit a plurality of program channels 120 to a plurality of set top boxes 110. The plurality of program channels 120 can be combined and decombined, as will be described more particularly below.

FIG. 2 is a flowchart of operations that may be performed for transmitting television programs according to various embodiments of the invention. These operations may be performed by the television broadcasting system 100 of FIG. 1.

Referring now to FIG. 2, a determination is made at Block 210 as to whether the plurality of program channels have common content (Yes) or whether at least some of the plurality of program channels have different content (No). If different content, then at Block 220, a plurality of program channels is transmitted when at least some of the plurality of program channels have different content. In contrast, if common content, then at Block 230, a single program channel is transmitted in place of the plurality of program channels when the plurality of program channels have common content.

FIG. 3 is a flowchart of operations that may be performed according to other embodiments of the present invention. In these embodiments, at Block 310, additional content is transmitted on at least one of the plurality of program channels when the plurality of program channels have common content.

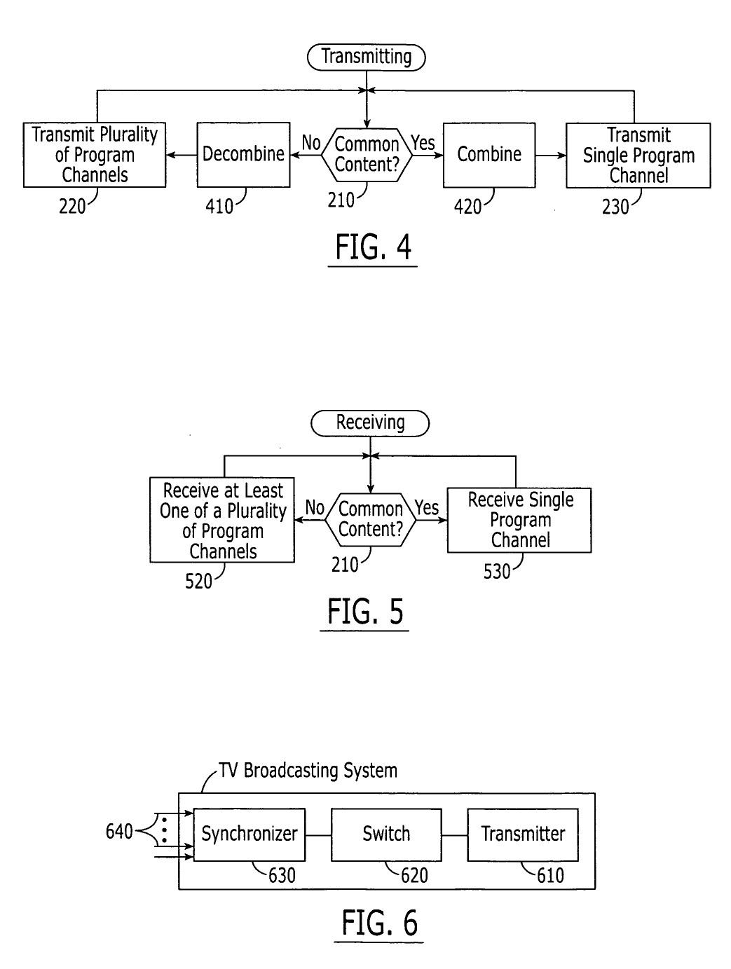

FIG. 4 is a block diagram of yet other embodiments of the present invention. As shown in FIG. 4, transmitting a plurality of program channels (Block 220) is preceded, at Block 410, by decombining the single program channel into the plurality of program channels when at least some of the plurality of program channels have different content. Moreover, transmitting the single channel at Block 230 is preceded by combining the plurality of program channels into the second program channel when the plurality of program channels have common content.

It will be understood that embodiments of FIGS. 2, 3 and/or 4 may be combined in various combinations and/or subcombinations. Moreover, in embodiments of FIGS. 2, 3 and/or 4, the operations of Blocks 220 and 230 may be repeatedly performed sequentially. FIGS. 2-4 also illustrate other embodiments of the present invention, that transmit a single channel of a program in place of a group of identical channels, and revert to transmission of the group of channels when the content being broadcast no longer is identical among the group of channels.

FIG. 5 is a flowchart of operations that may be performed according to other embodiments of the present invention. These operations may be performed in a set top box, such as a set top box 110 of FIG. 1. As shown in FIG. 5, the determination of Block 210 is again made. If no, then at least one of the plurality of program channels is received when at least some of the plurality of program channels have different content, at Block 520. If yes at Block 210, then a single program channel is received in place of at least one of the plurality of program channels when the plurality of program channels have common content at Block 530.

FIG. 6 is a block diagram of a television broadcasting system, such as a television broadcasting system 100 of FIG. 1. As shown in FIG. 6, in some embodiments, a transmitter 610 is configured to transmit a plurality of program channels 640 when at least some of the plurality of program channels 640 have different content, and to transmit a single program channel in place of the plurality of program channels 640 when the plurality of program channels have common content. A switch 620 also may be provided in some embodiments, that is configured to select the plurality of program channels in place of the single program channel when at least some of the plurality of program channels have different content, and to select the single program channel in place of the plurality of program channels when the plurality of program channels have common content. As shown, the transmitter 610 is responsive to the switch 620. Finally, in other embodiments, a synchronizer 630 is also provided that is configured to synchronize the switch between the single program channel and the plurality of program channels 640, and the switch 620 is responsive to the synchronizer.

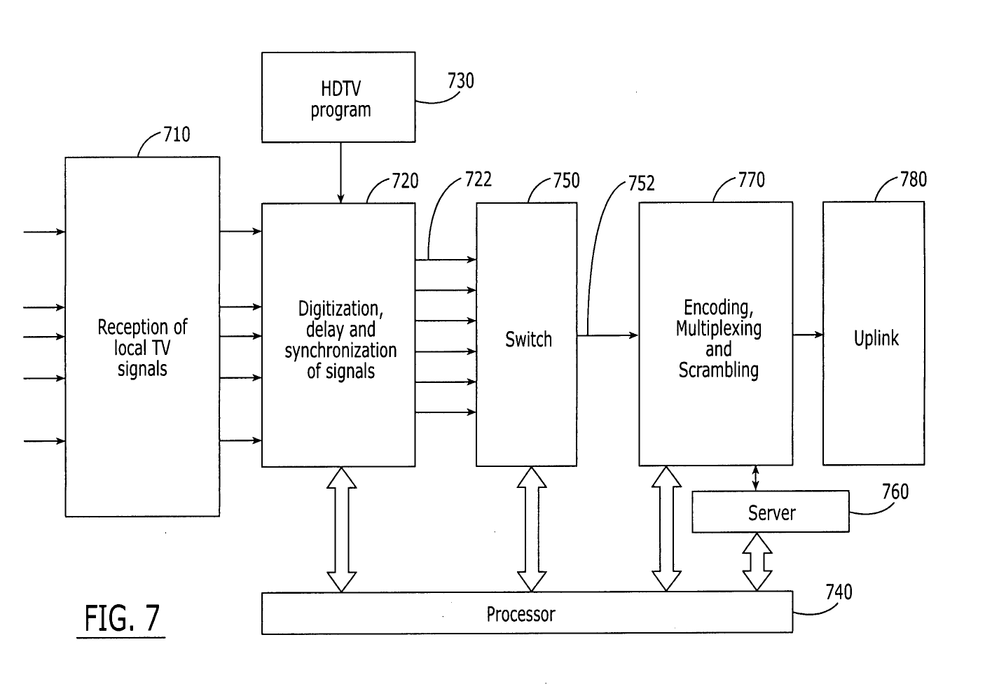

FIG. 7 is a block diagram of channel combining at a TV broadcasting system, such as a TV broadcasting system 100 of FIG. 1 according to other embodiments of the invention. The blocks of FIG. 7 are configured to combine channels.

Referring now to FIG. 7, TV signals are received in a receiver 710. The signals can be analog and/or digital and the transmission to the receiver 710 can be by satellite, fiber, over-the-air transmission and/or any other conventional techniques. The design of a receiver 710 is well known to those having skill in the art.

The signals are digitized (if necessary or desirable) and synchronized in a synchronizer 720. In particular, although signals may be selected because they are carrying identical content, there typically may be small differences in the absolute time at which individual stations start their programs. By delaying the signals in the group to be combined by differential amounts it is possible to account for their individual starting times and thus synchronize them. In some embodiments, the process of synchronization can be helped if the stations include start-of-program and end-of-program cues in their transmissions, but this is not essential to the invention. Synchronization may be performed so that switching between combined and de-combined channels can be substantially free of overlap artifacts.

When a group of channels is combined into one transmission by, for example, selecting one of the group for transmission, bandwidth can be made available. It is therefore possible to use a higher bit rate for the singular transmission and/or, as shown at Block 730, to insert and broadcast an HDTV version of the program. It is possible that all of the signals in the group are HDTV, and this is not precluded in this invention, and in fact can lead to a significant amount of bandwidth being made available. An HDTV program may be received before airtime and stored at Block 730. The material used in the singular transmission can be free of logos, animations or other station identifiers.

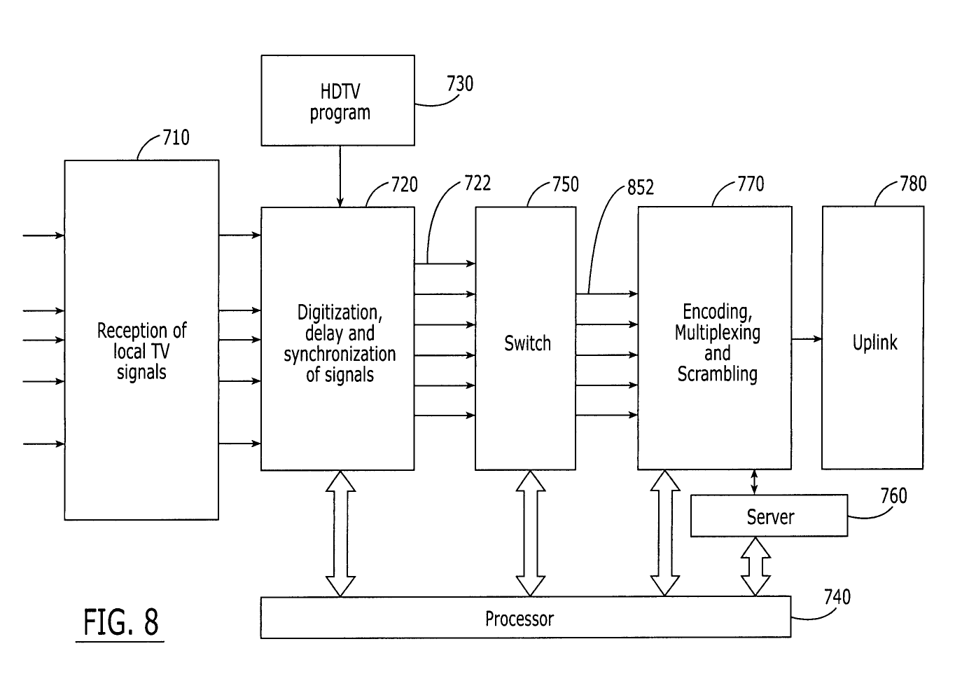

The synchronized group of signals 722 is fed to a switch 750. A processor 740 controls the output of the switch 750 so that only a singular output of common program material 752 is made (as shown in FIG. 7), or all of the channels in the group are output when different material is carried (as will be described below in connection with FIG. 8). Commercial insertion cues can be used in this process but need not be used in embodiments of the invention.

Each channel in the group may be identified by channel number in the DBS set top box (STB) program guide. These channel numbers may be associated with the channel number of the singular transmission that exists when channels are combined. The processor 740 also can control channel switching in the STB by inserting appropriate system data into the bit stream transmitted by the uplink 780. Operationally it may be desirable that the group of channels be in the same satellite transponder. If this is not the case, the channel switching transient in the STB can be reduced or masked by inserting freeze frame and/or other transitional effects before and after each switch point.

In particular, referring to FIG. 7, combining channels according to some embodiments of the present invention can free up excess bandwidth, some or all of which may be used to increase the program bit rate as described above. In general, not all the excess bandwidth need be used in this way. The excess bandwidth can also be used by a server 760 that injects packets of information into the bit stream as defined by the encoding, multiplexing and scrambling equipment 770 employed at an uplink station. The bit stream may be uplinked conventionally by an uplink 780. Other uses of the excess bandwidth may be provided.

A definite amount of the excess bandwidth can be apportioned to injection by the server 760, allowing deterministic scheduling of excess bandwidth. Any remaining excess, or all excess bandwidth, can be used opportunistically by the server 760. Information injected by the server 760 can be stored in the set top box and used for commercials, pay-per-view/listen programming, commercial or system data and/or other purposes.

FIG. 8 shows the TV broadcasting system of FIG. 7 configured after the group of channels has been de-combined, to provide a plurality of program channels 852 having different content.

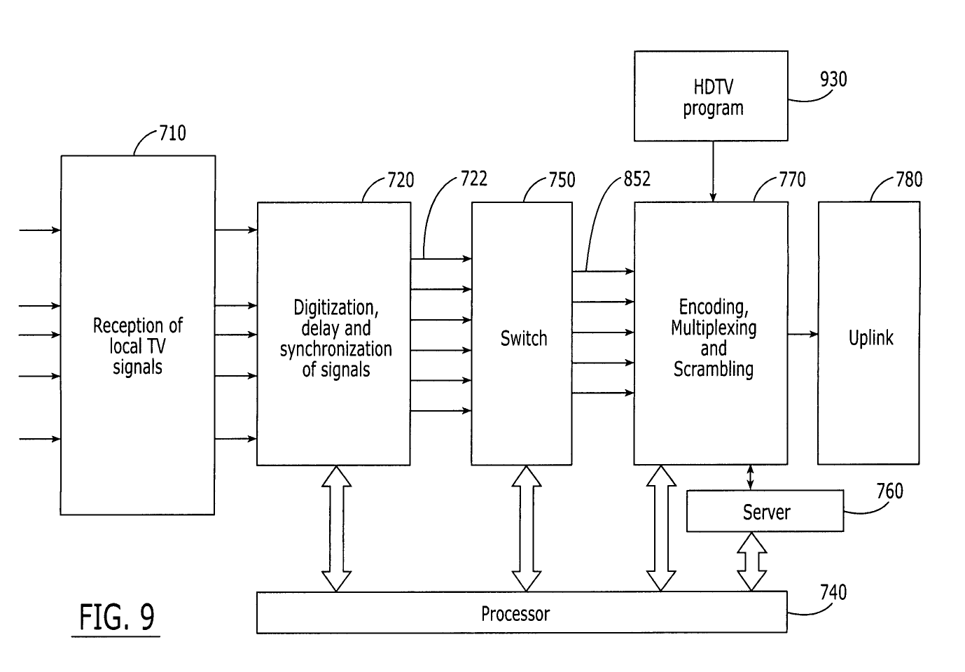

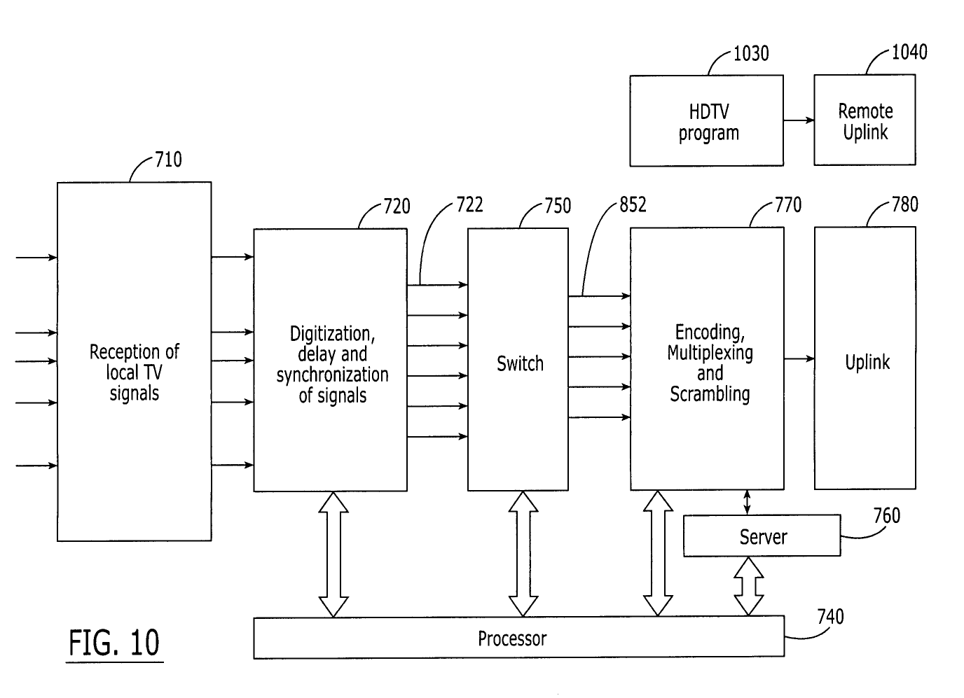

In other embodiments of the invention, the uplink of the HDTV program 930 can be independent of the channel combining equipment, as shown in FIG. 9. In yet other embodiments, the HDTV program 1030 and the HDTV uplink 1040 can be different from that of the channel combining uplink 780, as shown in FIG. 10. These embodiments may allow the HDTV channel to be a permanent channel on a national beam, for example. Conventional DBS systems may include such nationally broadcast HDTV channels. Embodiments of the invention can allow such a broadcast to incorporate local advertising 852 while limiting the HDTV bandwidth allocation to a single transmission of the HDTV material. In such embodiments the HDTV channel can be delayed by an amount equal to the largest delay experienced among the group(s) of channels to reduce or minimize overlap artifacts. It is also possible to define a start time for the HDTV program such that all channels that will be combined are delayed to reach the satellite(s) at the same time as the HDTV signal.

According to other embodiments of the invention, in a DBS system in which set top boxes have storage, channel combining and decombining can take place in the set top boxes, rather than in the broadcasting system, as described above. Programming can be downloaded into the set top box before the switch takes place. This programming may be trickled into the set top box at a low bit rate over an extended period of time, and/or downloaded at a high bit rate over a relatively short period of time, as satellite capacity becomes available. This programming may be stored in an encrypted form in the set top box so that it is unavailable or invisible to the local user until switch time.

In some embodiments, new or updated station identifier logos and animations can be continually transmitted over national or regional beams. The same mechanism can be used to distribute parameters and metadata used by the set top box to render these identifiers. These data are received by the set top box and stored locally.

The set top box also can store the current station number when a switch to combined programming occurs. Any station identifiers such as logos or animations can be rendered over the resultant video by the set top box using parameters or metadata stored therein. These metadata can control the process of rendering the station identifier and can include, but are not limited to, the level of transparency, the position of the station identifier, any movement associated with the station identifier, and/or a start and stop time for rendering the station identifier.

In the drawings and specification, there have been disclosed embodiments of the invention and, although specific terms are employed, they are used in a generic and descriptive sense only and not for purposes of limitation, the scope of the invention being set forth in the following claims.

What is claimed is:

1. A television program transmitting method comprising:
transmitting a plurality of program channels when at least some of the plurality of program channels have different content; and
transmitting a single program channel in place of the plurality of program channels when the plurality of program channels have common content.

2. A method according to claim 1 further comprising:
transmitting additional content on at least one of the plurality of program channels when the plurality of program channels have common content.

3. A method according to claim 1:
wherein transmitting a plurality of program channels is preceded by decombining the single program channel into the plurality of program channels when at least some of the plurality of program channels have different content; and
wherein transmitting a single program channel is preceded by combining the plurality of program channels into the single program channel when the plurality of program channels have common content.

4. A method according to claim 1 wherein the common content comprises national content, regional content or local content and wherein the different content comprises regional content, local content or commercials, respectively.

5. A method according to claim 1 wherein the common content comprises a common television program and wherein the different content comprises different commercials.

6. A method according to claim 2 wherein the additional content comprises a high bit rate transmission of the common content, High Definition Television (HDTV) content and/or content to be stored in a set top box.

7. A method according to claim 1 wherein transmitting a plurality of program channels is preceded by time synchronizing the plurality of program channels.

8. A method according to claim 2 wherein transmitting additional content comprises transmitting High Definition Television (HDTV) content on the plurality of program channels when the plurality of program channels have common content.

9. A method according to claim 1 wherein transmitting a plurality of program channels and transmitting a single program channel are repeatedly performed sequentially.

10. A method according to claim 1 wherein transmitting a plurality of program channels and transmitting a single program channel are performed by a Direct Broadcast Satellite (DBS) broadcasting system.

11. A channel combining and decombining method for a Direct Broadcast Satellite (DBS) system comprising:
transmitting a single channel of a program in place of a group of identical channels, and reverting to transmission of the group of channels when the content being broadcast no longer is identical among the group of channels.

12. A method according to claim 11 further comprising transmitting additional information on at least one channel in the group of channels while the singular channel is transmitted.

13. A television program receiving method comprising:
receiving at least one of a plurality of program channels when at least some of the plurality of program channels have different content; and
receiving a single program channel in place of at least one of the plurality of program channels when the plurality of program channels have common content.

14. A method according to claim 13 further comprising:
receiving additional content on at least one of the plurality of program channels when the plurality of program channels have common content.

15. A method according to claim 13 wherein the common content comprises a common television program and wherein the different content comprises different commercials.

16. A method according to claim 13 wherein receiving additional content comprises receiving High Definition Television (HDTV) content on at least one of the plurality of program channels when the plurality of program channels have common content.

17. A method according to claim 13 wherein receiving at least one of a plurality of program channels and receiving a single program channel are repeatedly performed sequentially.

18. A method according to claim 13 wherein receiving at least one of a plurality of program channels and receiving a single program channel are performed at a Direct Broadcast Satellite (DBS) set top box.

19. A television program broadcasting system comprising:
a transmitter that is configured to transmit a plurality of program channels when at least some of the plurality of program channels have different content and to transmit a single program channel in place of the plurality of program channels when the plurality of program channels have common content.

20. A system according to claim 19 wherein the transmitter is further configured to transmit additional content on at least one of the plurality of program channels when the plurality of program channels have common content.

21. A system according to claim 19 wherein the transmitter is a first transmitter, the system further comprising:
a second transmitter that is configured to transmit additional content on at least one of the plurality of program channels when the plurality of program channels have common content.

22. A system according to claim 19 further comprising:
a switch that is configured to select a plurality of program channels in place of the single program channel when at least some of the plurality of program channels have different content and to select the single program channel in place of the plurality of program channels when the plurality of program channels have common content, wherein the transmitter is responsive to the switch.

23. A system according to claim 19 wherein the common content comprises national content, regional content or local content and wherein the different content comprises regional content, local content or commercials, respectively.

24. A system according to claim 19 wherein the common content comprises a common television program and wherein the different content comprises different commercials.

25. A system according to claim 20 wherein the additional content comprises a high bit rate transmission of the common content, High Definition Television (HDTV) content and/or content to be stored in a set top box.

26. A system according to claim 22 further comprising a synchronizer that is configured to synchronize the plurality of program channels, wherein the switch is responsive to the synchronizer.

27. A system according to claim 19 wherein the television broadcast system comprises a Direct Broadcast Satellite (DBS) broadcast system.

28. A set top box comprising:
a receiver that is configured to receive at least one of a plurality of program channels when at least some of the plurality of program channels have different content and to receive a single program channel in place of the plurality of program channels when the plurality of program channels have common content.

29. A set top box according to claim 28 wherein the receiver is further configured to receive additional content on at least one of the plurality of program channels when the plurality of program channels have common content.

30. A set top box according to claim 28 wherein the common content comprises a common television program and wherein the different content comprises different commercials.

31. A set top box according to claim 29 wherein the additional content comprises High Definition Television (HDTV) content.

32. A set top box according to claim 28 wherein the set top box is a Direct Broadcast Satellite (DBS) set top box.

33. A television program transmitting system comprising:
means for transmitting a plurality of program channels when at least some of the plurality of program channels have different content; and
means for transmitting a single program channel in place of the plurality of program channels when the plurality of program channels have common content.

34. A system according to claim 33 further comprising:
means for transmitting additional content on at least one of the plurality of program channels when the plurality of program channels have common content.
